(19) United States
(12) Patent Application Publication
(10) Pub. No.: US 2012/0084095 A1
(43) Pub. Date: Apr. 5, 2012

(54) PATIENT BURDEN EASING SUPPORT APPARATUS, PATIENT BURDEN EASING SUPPORT METHOD AND COMPUTER READABLE MEDIUM

(75) Inventors: Goro MIURA, Tokyo (JP); Kunimasa SHIMIZU, Tokyo (JP); Yasuhiro ASAI, Tokyo (JP); Takayoshi KIUCHI, Tokyo (JP); Hidehito SAKURAI, Tokyo (JP)

(73) Assignee: FUJIFILM CORPORATION, Tokyo (JP)

(21) Appl. No.: 13/248,183

(22) Filed: Sep. 29, 2011

(30) Foreign Application Priority Data
Sep. 30, 2010 (JP) 2010-223281

(51) Int. Cl. G06Q 50/24

(52) U.S. Cl. 705/2

(57) ABSTRACT

An endoscopic sector server as a patient burden easing support apparatus executes a step of acquiring preparation completion information indicating that preparation for an endoscopic inspection has been completed, a step of acquiring inspection start information indicating that the endoscopic inspection has been started, a determination step of determining whether predetermined conditions about a time between acquisition of the preparation completion information and acquisition of the inspection start information are satisfied or not, and a warning step of outputting warning information when determination is made that the predetermined conditions are satisfied.

### CROSS-REFERENCE TO RELATED APPLICATIONS

This application claims the benefit of Japanese Patent Application No. 2010-223281, filed on Sep. 30, 2010, the entire contents of which are hereby incorporated by reference, the same as if set forth at length; the entire of which are incorporated herein by reference.

### BACKGROUND OF THE INVENTION

1. Technical Field

The present invention relates to a patient burden easing support apparatus, a patient burden easing support method and a related computer readable medium.

2. Description of Related Art

To shorten waiting time before start of a medical examination after reception in a hospital is an important problem to ease stress on patients. Patients often feel stress not only due to long waiting time but also due to lack of a prospect about how long the patients will have to wait until start of the medical examination.

JP-A-11-308344 and JP-A-09-264979 have disclosed a system which notifies a user of estimated time to start service or treatment, so as to ease the user's stress.

Even when the user is notified of the estimated time to start service or treatment, it is difficult to shorten the waiting time itself unless a provider of the service or a person performing of the treatment recognizes that the user is kept waiting for a long time.

In order to make it possible to shorten the waiting time itself in a hospital, JP-A-2007-279859 has disclosed a system which gives a warning to the hospital side and urges the hospital side to make proper arrangement of personnel as soon as the waiting time of any patient is beyond a threshold.

### SUMMARY

The system disclosed in JP-A-2007-279859 monitors waiting time before start of treatment on a patient after acceptance of the patient in a hospital and gives a warning when the waiting time is beyond a threshold. However, of inspections performed in the hospital, endoscopic inspections often have occasions to let a patient wait in an inspection room for a long time after the patient is called into the inspection room. The system according to JP-A-2007-279859 cannot prevent such an event from occurring.

An endoscopic inspection typically proceeds in the following flow. First, a doctor or a nurse performs workings and various settings required for the inspection, including powering on an endoscopic device for the inspection, setting an endoscopic probe in the device, etc. Thus, preparation for the endoscopic inspection is completed.

As soon as the preparation is completed, an image which is being taken by an endoscope is displayed as a preview motion picture on a display portion connected to the endoscopic device and the device stands by until an image for the inspection is taken. After the completion of the preparation, the doctor or the nurse calls a patient into an inspection room, and makes the patient lie on an inspection bed. In that state, the doctor or the nurse makes the patient wait until start of the inspection.

After the completion of the preparation, the doctor who is confirming the preview motion picture inserts the endoscopic probe into the body of the patient so as to allow a front end portion of the endoscope to reach a region to be inspected. As soon as the front end portion of the endoscope reaches the region to be inspected, the doctor takes an image for the inspection.

In such a flow, there are a large number of occasions in which it takes time before the endoscopic inspection (insertion of the endoscopic probe) is started by the doctor after the preparation for the endoscopic inspection is completed and the patient is called into the inspection room. Thus, the aforementioned event often occurs.

An endoscopic inspection is carried out with an endoscopic probe inserted into a body of a patient. Therefore, physical or mental anguish of the patient is larger than that in any other inspection such as mammography inspection, X-ray inspection or blood test. Nevertheless, the patient has a large mental burden because the patient is made to wait for a long time before start of the inspection (insertion of the endoscopic probe) after the patient is called into the inspection room.

According to the system disclosed in JP-A-2007-279859, it is possible to shorten the waiting time before a patient is called into an inspection room for an endoscopic inspection after acceptance of the patient. However, JP-A-2007-279859 does not give any consideration how to reduce waiting time after the patient enters the inspection room.

The present invention was developed in consideration of the aforementioned circumstances. An object of the invention is to provide a patient burden easing support apparatus, a patient burden easing support method and a patient burden easing support program, in which a mental burden on a patient in an endoscopic inspection can be eased.

A patient burden easing support apparatus offers support to ease a burden on a patient who receives an endoscopic inspection. The patient burden easing support apparatus includes a preparation completion information acquiring unit, an inspection start information acquiring unit, a determination unit and a warning unit. The preparation completion information acquiring unit acquires preparation completion information indicating that preparation for the endoscopic inspection has been completed. The inspection start information acquiring unit acquires inspection start information indicating that the endoscopic inspection has been started. The determination unit determines whether predetermined conditions about a time between acquisition of the preparation completion information and acquisition of the inspection start information are satisfied or not. The warning unit outputs warning information when the determination unit determines that the predetermined conditions are satisfied.

A patient burden easing support method offers support to ease a burden on a patient who receives an endoscopic inspection, which is performed by a computer. The patient burden easing support method includes: acquiring preparation completion information indicating that preparation for the endoscopic inspection has been completed; acquiring inspection start information indicating that the endoscopic inspection has been started; determining whether predetermined conditions about a time between acquisition of the preparation completion information and acquisition of the inspection start information are satisfied or not; and outputting warning information when the determining step determines that the predetermined conditions are satisfied.

A non-transitory computer readable medium causes a computer to execute each process of the patient burden easing support method.

According to the invention, it is possible to provide a patient burden easing support apparatus which can ease a mental burden on a patient in an endoscopic inspection.

### BRIEF DESCRIPTION OF THE DRAWINGS

FIG. 1 is a diagram showing an overall configuration of an intrahospital system.

FIG. 2 is a diagram showing a schematic configuration of an endoscopic sector system in the system shown in FIG. 1.

FIG. 3 is a diagram showing a schematic configuration of a client PC in the endoscopic sector system shown in FIG. 2.

FIG. 4 is a view showing a basic screen of an application installed in the client PC shown in FIG. 2.

FIG. 5 is a flow chart of operation for patient care control executed in the endoscopic sector system shown in FIG. 2.

FIG. 6 is a diagram showing a modification of the endoscopic sector system shown in FIG. 2.

FIG. 7 is a flow chart of operation for patient care control executed in the endoscopic sector system shown in FIG. 6.

### DETAILED DESCRIPTION OF EMBODIMENTS OF THE INVENTION

An embodiment of the invention will be described below with reference to the drawings.

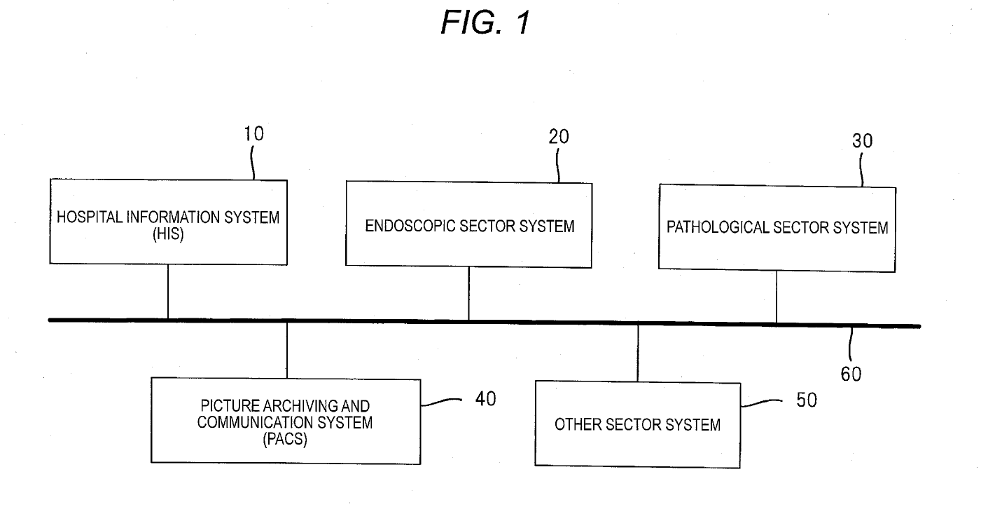

FIG. 1 is a diagram showing an overall configuration of an intrahospital system. The system shown in FIG. 1 includes a hospital information system (HIS) 10, an endoscopic sector system 20, a pathological sector system 30, a picture archiving and communication system (PACS) 40, and an other sector system 50. These systems 10 to 50 are connected to an intrahospital LAN 60 so that these systems 10 to 50 can work with one another.

The HIS 10 is a comprehensive system including a medical coding/billing system, a medical practice reservation system, a medical practice information system, etc. The HIS 10 has an electronic medical record database etc. Electronic medical records in which practice information of patients has been recorded are stored in the electronic medical record database.

Assume that an inspection request from another medical department is sent to the endoscopic sector. When information about the inspection request (order) (hereinafter referred to as inspection request information) in this case is issued, the inspection request information is transmitted to the endoscopic sector system 20 through the HIS 10.

For example, the inspection request information includes patient's information, order key information (“order number”, “date and time of occurrence”, etc.), request source information (“requesting department name”, “requesting doctor name”, “request date”, etc.), order information (“requested disease name”, “inspection purpose”, “inspection kind”, “inspection item”, “inspection region”, “comment”, etc.), inspection reservation information (“inspection date”, “conducting time”, etc.), etc. The patient's information is information about a patient, including “patient ID as patient-specific information”, “patient name”, “birth date”, “age”, “sex”, “inpatient/outpatient distinction”, etc.

The endoscopic sector system 20 is a system for administering the endoscopic sector.

The pathological sector system 30 is a system for administering a pathological sector.

The PACS 40 is a system for electronically storing, retrieving and analyzing each inspection image from a medical image diagnostic device such as an endoscopic device, a CT or an MRI.

The other sector system 50 is a system for administering the other sectors.

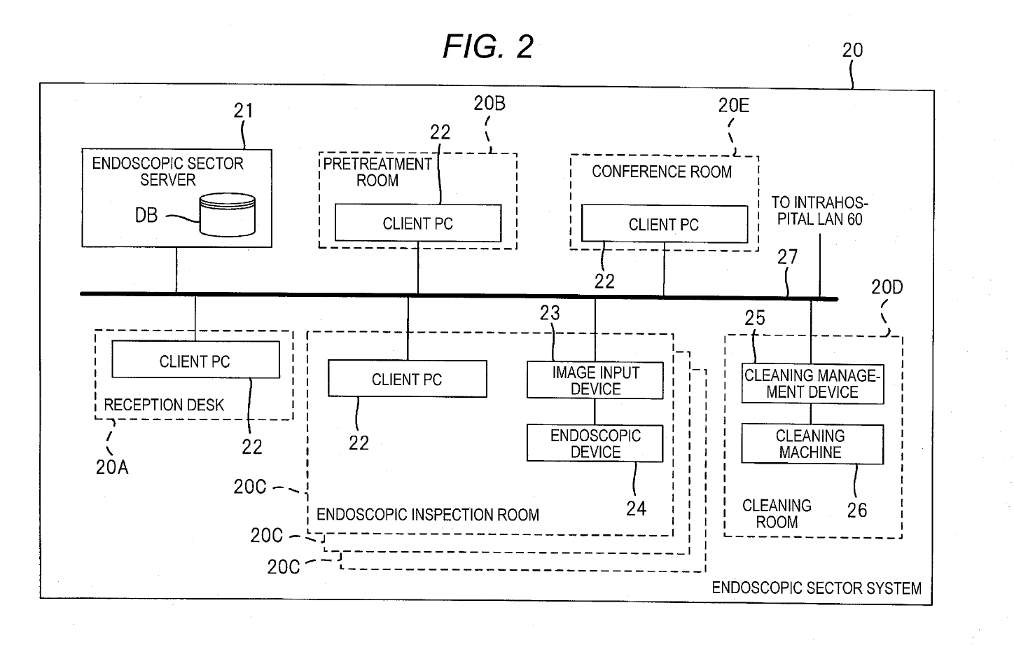

FIG. 2 is a diagram showing a schematic configuration of an example of the endoscopic sector system in the system shown in FIG. 1. The endoscopic sector includes a reception desk 20A, a pretreatment room 20B, endoscopic inspection rooms (hereinafter referred to as inspection rooms) 20C, a cleaning room 20D, and a conference room 20E.

The reception desk 20A is a site for accepting inspections. The pretreatment room 20B is a room for interview and pretreatment before endoscopic inspection. The inspection rooms 20C are rooms for endoscopic inspections. The cleaning room 20D is a room for cleaning endoscopes etc. used for the endoscopic inspections.

The endoscopic sector system 20 shown in FIG. 2 has an endoscopic sector server 21, client PCs 22, image input devices 23, endoscopic inspection devices (endoscopic devices) 24, a cleaning management device 25 and a cleaning machine 26. The endoscopic sector server 21, the client PCs 22, the image input devices 23, and the cleaning management device 25 are connected to an intrasectoral LAN 27. The intrasectoral LAN 27 is connected to the intrahospital LAN 60.

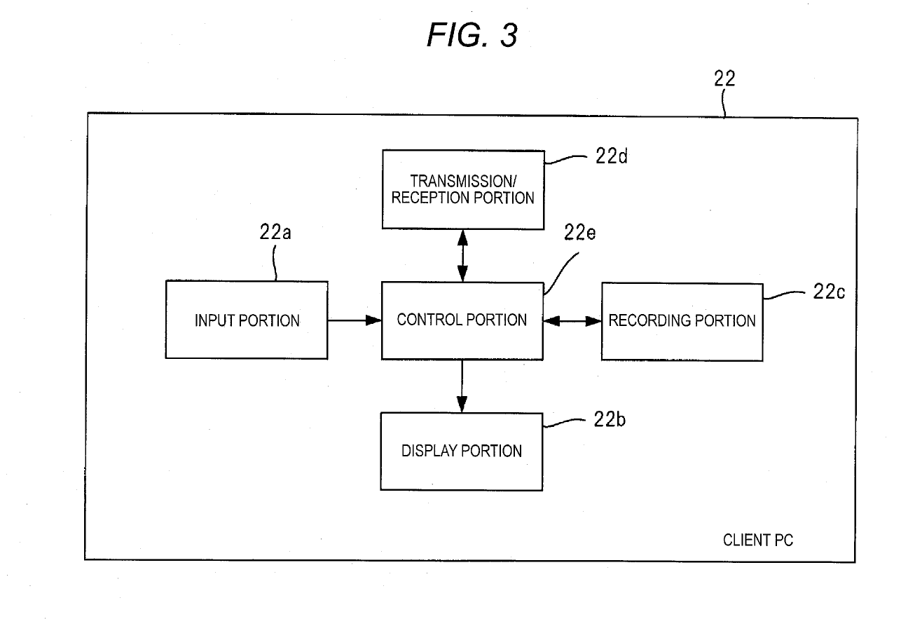

FIG. 3 is a block diagram showing an internal configuration of each client PC in the endoscopic sector system shown in FIG. 2. As shown in FIG. 3, each client PC 22 includes an input portion 22a, a display portion 22b, a recording portion 22c, a transmission/reception portion 22d and a control portion 22e.

The input portion 22a is an input unit for performing various inputs. The input portion 22a is constituted by input devices such as a keyboard and a touch panel, and pointing devices such as a mouse and a trackball.

The display portion 22b is a display device for performing various displays such as an image and a report. The display portion 22b is constituted by an LCD, a CRT, or the like.

The recording portion 22c is constituted by a hard disk or the like for recording various data.

The transmission/reception portion 22d is constituted by a transmission/reception interface circuit or the like to execute processing for transmitting/receiving various instructions, various requests and various data through the intrasectoral LAN 27.

The control portion 22e includes a processor such as a CPU (Central Processing Unit), a program memory portion such as an ROM (Read-Only Memory) for storing programs, and a storage portion.

The storage portion in the control portion 22e is constituted by a system memory, a nonvolatile RAM (Random Access Memory) or the like, which forms work areas for executing the programs.

The control portion 22e performs control on the respective portions of the client PC 22 in accordance with the aforementioned programs, various requests transmitted from the outside through the intrasectoral LAN 27, instruction information inputted from the input portion 22a, etc.

The image input devices 23 and the endoscopic inspection devices 24 are placed in the inspection rooms 20C respectively.

Each image input device 23 is connected to the endoscopic inspection device 24 in the inspection room 20C where the image input device 23 is placed. The image input device 23 is a device by which image data obtained by taking images with the endoscopic inspection device 24 connected thereto is inputted to the endoscopic sector server 21. The image data inputted by the image input device 23 is archived by the PASC 40 under the control of the endoscopic sector server 21. Alternatively, an endoscopic inspection device integrated with the image input device 23 may be used as the endoscopic inspection device 24.

The cleaning machine 26 and the cleaning management device 25 are placed in the cleaning room 20D. The cleaning machine 26 is a device for cleaning endoscopes etc. used for endoscopic inspections.

The cleaning management device 25 is a computer which is connected to the cleaning machine 26 and by which information of a cleaning history or the like of the cleaning machine 26 is registered in the endoscopic sector server 21.

The endoscopic sector server 21 is a computer for generally controlling the client PCs 22, the image input devices 23, and the cleaning management device 25. A database DB is built in the endoscopic sector server 21. Various kinds of information (inspection request information, inspection result information etc.) are stored in the database DB.

A predetermined application program is installed in each client PC 22. Reference/edition of data recorded in the database DB, registration of data into the database, etc. can be performed by this program.

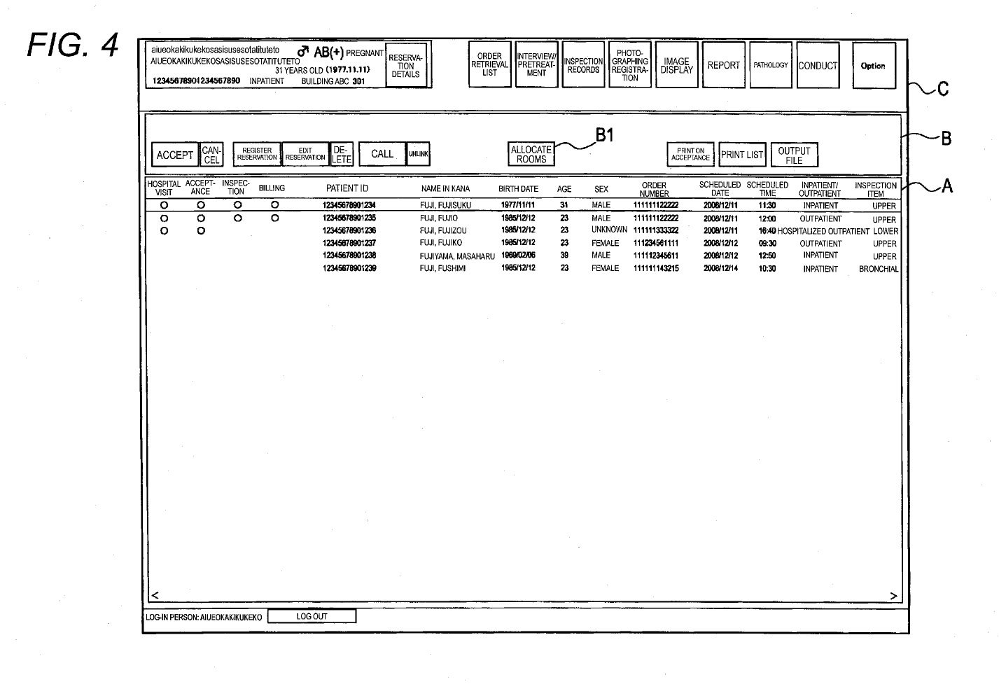

For example, a basic screen of the application is shown in FIG. 4. When a user starts up the application on a client PC 22 and logs into the application, the control portion 22e acquires basic screen data from the database DB and displays the basic screen shown in FIG. 4 on the display portion 22b. The basic screen consists of a region A where a list of pieces of inspection request information (partially extracted information) is displayed, a region B where various operation buttons are displayed, and a region C where a launcher effective for a selected one from the pieces of inspection request information in the list is displayed.

Processing items “hospital visit”, “acceptance”, “inspection”, “billing”, etc. are displayed in the list of the region A. When the processing shown in each processing item is completed, a mark “o” is displayed in the processing item. Data for displaying the mark is registered in the database DB by the endoscopic sector server 21 as soon as the processing is completed. For example, as soon as an inspection based on a piece of inspection request information is completed, the endoscopic sector server 21 registers information which indicates the completion of the inspection, into the database DB in association with the piece of inspection request information. In this manner, the mark “o” is displayed in the processing item “inspection”. Information indicating whether each processing has been completed or not may be inputted manually, or may be notified automatically by each client PC 22 or each endoscopic inspection device 24.

The control portion 22e of the client PC 22 periodically acquires data for displaying this basic screen from the database DB, and displays the basic screen on the display portion 22b.

The endoscopic sector system 20 configured thus performs control (patient care control) to give a warning through a client PC 22 to a person who is watching the client PC 22 when a time that a patient has been made to wait after completion of preparation for an endoscopic inspection is long. Thus, the mental burden on the patient can be eased even slightly.

Specifically, the endoscopic sector server 21 has an internal memory which stores a program for performing the patient care control. A CPU (Central Processing Unit) in the endoscopic sector server 21 executes the program to perform the patient care control which will be described below.

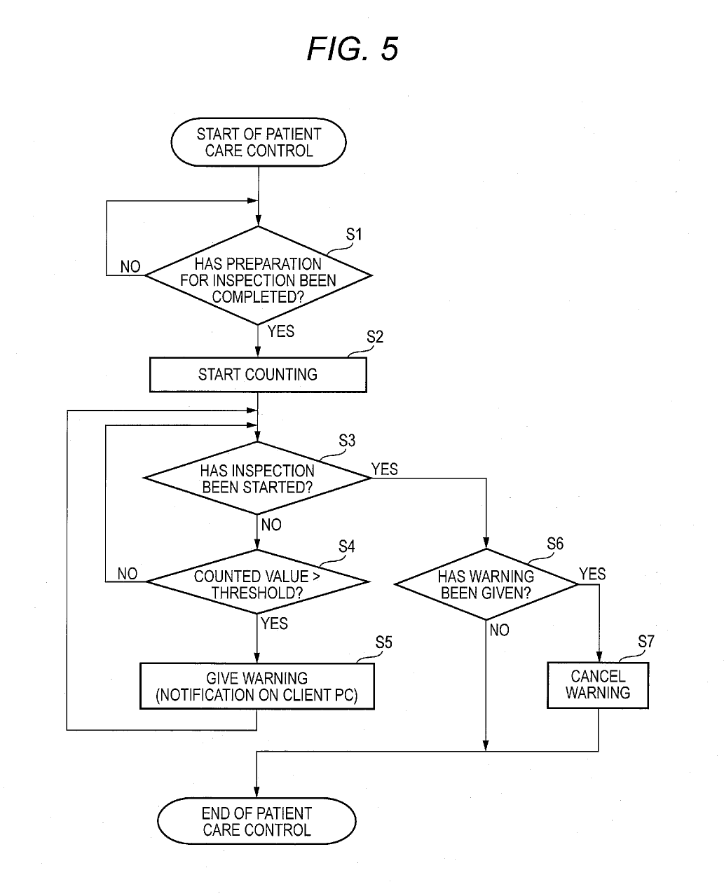

FIG. 5 is a flow chart of operation for the patient care control executed in the endoscopic sector system 20 shown in FIG. 2. The endoscopic sector server 21 carries out processing shown in FIG. 5 for each inspection room 20c.

First, the endoscopic sector server 21 determines whether preparation for an endoscopic inspection is completed in the inspection room 20c or not (Step S1).

For example, as soon as setting of the endoscopic device 24 or the like is completed so that preparation is completed, a preview motion picture is outputted from the endoscopic device 24. When the preview motion picture is received through the image input device 23, the endoscopic sector server 21 concludes that preparation for an endoscopic inspection is completed. When the preview motion picture has not been received, the endoscopic sector server 21 concludes that preparation for an endoscopic inspection has not been completed.

Alternatively, a doctor or a nurse may operate the client PC 22 in the inspection room 20c manually to notify the endoscopic sector server 21 of completion of the preparation so that the endoscopic sector server 21 can determine whether the preparation is completed or not, based on existence of the notification of inputted information. The first frame of the preview motion picture or the inputted information serves as preparation completion information indicating completion of the inspection preparation.

As soon as the preparation completion information is acquired (YES in Step S1), the endoscopic sector server 21 starts to count a time elapsed since the preparation completion information is acquired (Step S2).

Next, the endoscopic sector server 21 determines whether the endoscopic inspection has been started or not (Step S3).

For example, on receiving image data obtained by the first shot carried out with an endoscope by the doctor, the endoscopic sector server 21 concludes that the endoscopic inspection has been started.

Alternatively, the doctor or the nurse may operate the client PC 22 or the like in the inspection room 20c manually to notify the endoscopic sector server 21 of the start of the inspection so that the endoscopic sector server 21 can determine whether the inspection has been started or not, based on existence of the notification of inputted information. The image data obtained by the first shot or the inputted information serves as inspection start information indicating the start of the inspection. The following description will be made on the assumption that the endoscopic sector server 21 determines whether the inspection has been started or not, based on acquisition of the image data obtained by the first shot.

When the inspection start information is not acquired (NO in Step S3), the endoscopic sector server 21 determines whether the time elapsed since acquisition of the preparation completion information is longer than a threshold or not. When the elapsed time is longer than the threshold (YES in Step S4), the endoscopic sector server 21 performs processing of Step S5. When the elapsed time is not longer than the threshold (NO in Step S4), the endoscopic sector server 21 performs processing of Step S3.

In Step S5, the endoscopic sector server 21 concludes that the patient is kept waiting for a long time since completion of the inspection preparation, so that the endoscopic sector server 21 performs warning processing to notify the doctor, the nurse or other stuffs of the hospital of the fact that the patient is kept waiting.

Specifically, the endoscopic sector server 21 displays information, which indicates the fact that there is a waiting patient, on the screen shown in FIG. 4, so as to give a warning to the person who opens the screen shown in FIG. 4. For example, character information “A patient is kept waiting for start of inspection in Inspection Room **. Please take care of the patient as quickly as possible.” is displayed on the screen shown in FIG. 4.

The information for giving a warning is not limited to the screen shown in FIG. 4 but may be displayed on any screen if the screen can be displayed by the client PC 22. When the information is displayed on any screen, information (room number, attending doctor, etc.) of the inspection room 20c where the waiting patient is and the warning message may be displayed in association with each other at some place on the screen. For example, character information “A patient is kept waiting in Inspection Room ** (attending doctor: x x x). Please take care of the patient as quickly as possible.” may be displayed to be easily recognized on the screen. In addition, warning sound may be issued in addition to the character information.

In this manner, a person who stays on a client PC 22 side can recognize the fact that the patient is kept waiting. The person can make a phone call to the inspection room 20c where the patient is, and inform that the patient has to be taken care of, or urge the doctor of the inspection room 20c to hasten start of the inspection. Thus, the mental burden on the patient can be eased.

In the aforementioned Step S3, the point of time when the first shot is taken is regarded as the inspection start time point. Accordingly, the patient's actual waiting time is regarded as a time obtained by subtracting the time until start of the first shot from insertion of an endoscope into the body of the patient from the time between the inspection preparation completion time point and the inspection start time point. Therefore, the threshold for comparison with the elapsed time in Step S4 has to be set at a value in which the time (average time) between the insertion of the endoscope into the body of the patient and the start of the first shot is taken into consideration.

For example, assume that the system is built to give a warning when there is a patient kept waiting for 10 or more minutes. Assume that it takes 5 minutes to start the first shot after the endoscope is inserted into the body of the patient. In this case, if the threshold for comparison with the elapsed time in Step S4 is set at 10 minutes, a warning will be given though the patient is kept waiting for only 5 minutes.

The time between the insertion of the endoscope into the body of the patient and the start of the first shot also varies in accordance with a region (upper portion or lower portion) to be inspected or the level of skill of the doctor. It is therefore preferable that the threshold is registered in the endoscopic sector server 21 in advance as a value which may vary in accordance with at least one of a region to be inspected and a procedure of an attending doctor.

Return to description concerned with the flow chart. On concluding that the inspection has been started in Step S3, the endoscopic sector server 21 determines whether a warning has been given or not. When a warning has been given (YES in Step S6), the endoscopic sector server 21 cancels the warning (Step S7), and then terminates the patient care control. When no warning has been given (NO in Step S6), the endoscopic sector server 21 terminates the patient care control directly.

When the patient care control is carried out thus, the mental burden on a patient in an endoscopic inspection can be eased so that it is possible to prevent useless trouble with the patient or improve patient's satisfaction with the hospital.

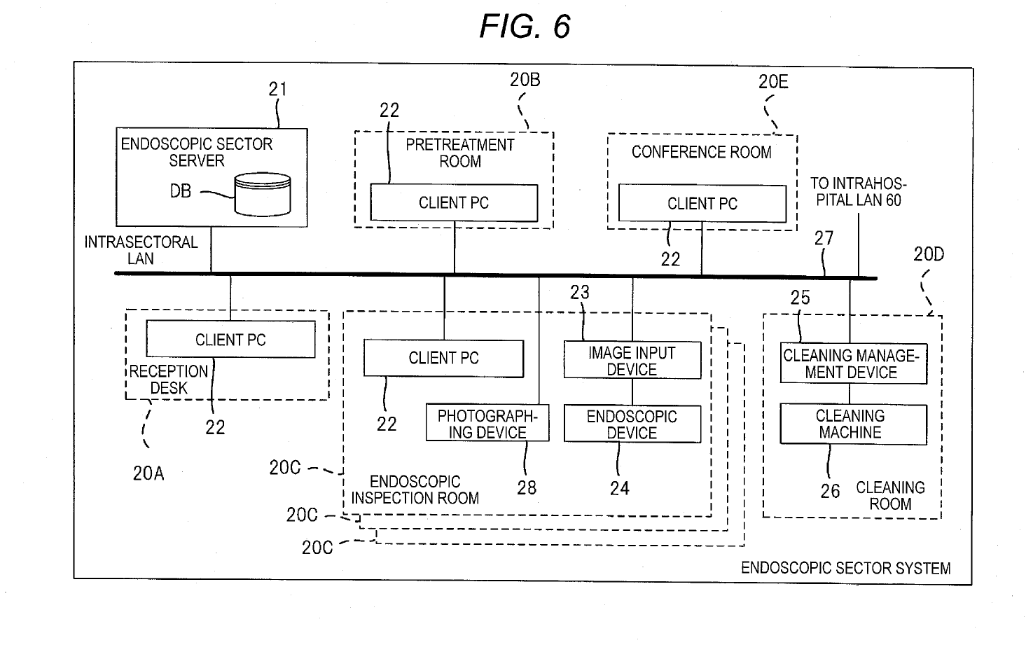

FIG. 6 is a diagram showing a modification of the endoscopic sector system shown in FIG. 2. The endoscopic sector system shown in FIG. 6 has the same configuration as that of FIG. 2, except that a photographing device 28 is added to each inspection room 20C.

The photographing device 28 is a network camera connected to the intrasectoral LAN 27 and controlled by the endoscopic sector server 21. The photographing device 28 photographs an image of the inside of the inspection room 20C where the photographing device 28 is placed, and transmits data of the photographed image obtained thus to the endoscopic sector server 21.

A table in which the serial number of each photographing device 28 is associated with the name of the inspection room 20C where the photographing device 28 is placed is registered in the database DB of the endoscopic sector server 21 in advance. Based on the serial number of the photographing device 28 serving as a sender of photographed image data and the table, the endoscopic sector server 21 can recognize the name of the inspection room 20C where the photographing device 28 is placed.

In the endoscopic sector system according to this modification, the endoscopic sector server 21 has an internal memory for storing a program for patient care control. A CPU (Central Processing Unit) in the endoscopic sector server 21 executes the program to perform the patient care control which will be described below.

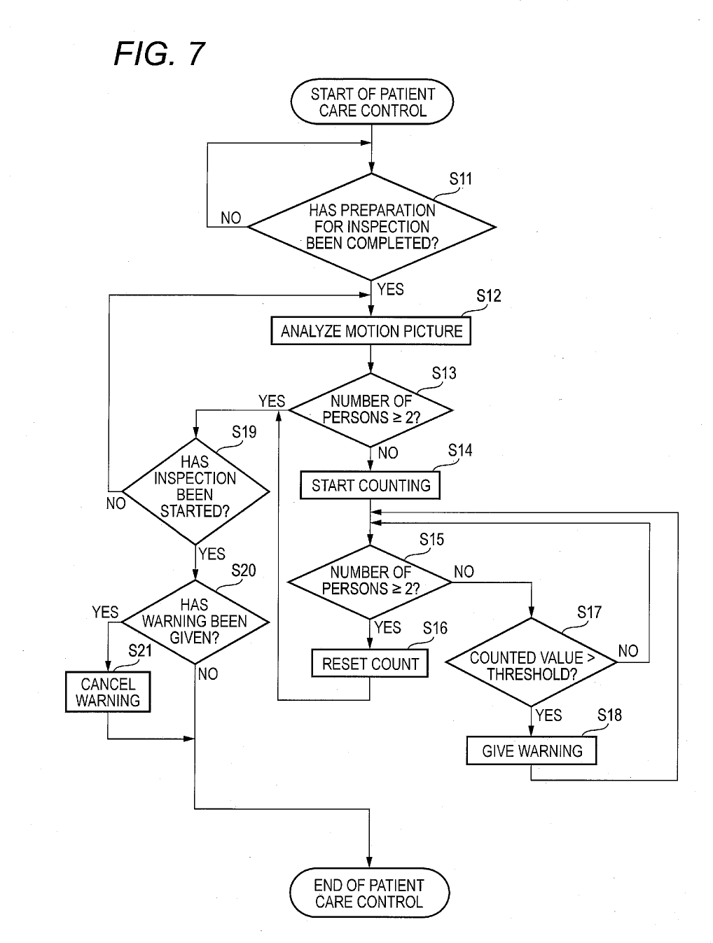

FIG. 7 is a flow chart of operation for the patient care control executed in the endoscopic sector system shown in FIG. 6. The endoscopic sector server 21 carries out processing shown in FIG. 7 for each inspection room 20c.

First, the endoscopic sector server 21 determines whether preparation for an endoscopic inspection is completed in the inspection room 20c or not (Step S11). The method for the determination is similar to the method described in the flow chart of FIG. 5.

On acquiring the preparation completion information (YES in Step S11), the endoscopic sector server 21 starts analysis of a motion picture transmitted from the photographing device 28 placed in the inspection room 20c (Step S12). Specifically, the number of persons included in the motion picture is detected in combination with a known face detection process, a moving body detection process, etc.

When the number of persons included in the motion picture is two or more as a result of the analysis (YES in Step S13), the endoscopic sector server 21 executes processing of Step S19. When the number of persons included in the motion picture is smaller than two (NO in Step S13), the endoscopic sector server 21 executes processing of Step S14.

In Step S14, the endoscopic sector server 21 starts to count a time elapsed after the number of persons included in the motion picture becomes smaller than two. Next, as soon as the number of persons included in the motion picture reaches two or more (YES in Step S15), the endoscopic sector server 21 resets the elapsed time which is being counted (Step S 16), and executes the processing of Step S19. When the number of persons included in the motion picture remains smaller than two (NO in Step S15), the endoscopic sector server 21 compares the counted elapsed time with a threshold in Step S17.

When the counted value (elapsed time) is beyond the threshold as a result of the comparison in Step S17, the endoscopic sector server 21 can conclude that only the patient is kept waiting in the inspection room 20c for a time beyond the threshold in spite of the completion of preparation for inspection. The endoscopic sector server 21 therefore gives a warning in the same manner as described in FIG. 5 (Step S18).

When the counted value (elapsed time) is lower than the threshold as a result of the comparison in Step S17, or after the processing of Step S18, the processing of Step S15 is performed again.

In Step S19 performed after YES in Step S13 or after Step S16, the endoscopic sector server 21 determines whether the endoscopic inspection has been started in the inspection room 20c or not. The method of this determination is performed in a similar manner to the method described in FIG. 5.

On concluding in Step S19 that the inspection has been started, the endoscopic sector server 21 determines whether a warning has been given or not. When a warning has been given (YES in Step S20), the endoscopic sector server 21 cancels the warning (Step S21) and then terminates the patient care control. When no warning has been given (NO in Step S20), the endoscopic sector server 21 terminates the patient care control directly.

The threshold to be compared with the counted value in Step S17 may be set at a value which is a tolerable time that any patient can be kept waiting alone after completion of preparation for inspection. The threshold does not have to be changed for each doctor or each region to be inspected.

According to the patient care control configured thus, a warning required for taking care of a patient can be given when the time that the patient is kept waiting alone after completion of preparation for inspection is beyond the threshold.

The cases where a patient is kept waiting after completion of preparation for inspection are classified into the case where the patient is kept waiting though a doctor or a nurse is in the inspection room 20c and the case where the patient is kept waiting alone in the inspection room 20c. In the former case, the necessity of giving a warning is low because the person to take care of the patient is in the inspection room 20c. On the other hand, in the latter case, the necessity of giving a warning is high because the patient has a stronger feeling of insecurity.

According to the patient care control shown in FIG. 7, a warning can be given only after the latter case is recognized. Thus, efficient control can be performed without causing any waste. On the other hand, according to the patient care control shown in FIG. 5, it is not necessary to provide any photographing device in the inspection room 20c. Thus, the cost to build the system can be suppressed.

As described above, the following items are disclosed herein.

A disclosed patient burden easing support apparatus offers support to ease a burden on a patient who receives an endoscopic inspection. The patient burden easing support apparatus includes a preparation completion information acquiring unit, an inspection start information acquiring unit, a determination unit and a warning unit. The preparation completion information acquiring unit acquires preparation completion information indicating that preparation for the endoscopic inspection has been completed. The inspection start information acquiring unit acquires inspection start information indicating that the endoscopic inspection has been started. The determination unit determines whether predetermined conditions about a time between acquisition of the preparation completion information and acquisition of the inspection start information are satisfied or not. The warning unit outputs warning information when the determination unit determines that the predetermined conditions are satisfied.

In the disclosed patient burden easing support apparatus, the determination unit determines that the predetermined conditions are satisfied when a time elapsed since acquisition of the preparation completion information is beyond a first threshold, and determines that the predetermined conditions are not satisfied when the elapsed time does not reach the first threshold.

In the disclosed patient burden easing support apparatus, the first threshold is a value which varies in accordance with at least one of a region to be inspected in the endoscopic inspection and a procedure of a doctor who performs the endoscopic inspection.

In the disclosed patient burden easing support apparatus, the determination unit determines that the predetermined conditions are satisfied when a time in which a subject who receives the endoscopic inspection is alone in a room where the endoscopic inspection is performed is beyond a second threshold, and determines that the predetermined conditions are not satisfied when the time does not reach the second threshold.

The disclosed patient burden easing support apparatus further includes a motion picture data acquiring unit and a number-of-persons determination unit. The motion picture data acquiring unit acquires data of a motion picture in a room where an endoscopic device for performing the endoscopic inspection is placed. The motion picture is imaged by a photographing device for photographing the inside of the room. The number-of-persons determination unit determines the number of persons included in the motion picture data, based on the motion picture data. The determination unit determines that a time in which the number of persons is smaller than two, as the time in which the subject is alone in the room where the endoscopic inspection is performed.

In the disclosed patient burden easing support apparatus the inspection start information is data of a taken image obtained by a first still picture taken after connection of an endoscopic probe in an endoscopic device for performing the endoscopic inspection.

In the disclosed patient burden easing support apparatus the preparation completion information is a first frame of a motion picture taken after connection of an endoscopic probe in an endoscopic device for performing the endoscopic inspection.

In the disclosed patient burden easing support apparatus the warning information is information for sending a notification that a subject is kept waiting for a long time since completion of preparation for the endoscopic inspection.

A disclosed patient burden easing support method offers support to ease a burden on a patient who receives an endoscopic inspection, which is performed by a computer. The patient burden easing support method includes: acquiring preparation completion information indicating that preparation for the endoscopic inspection has been completed;

acquiring inspection start information indicating that the endoscopic inspection has been started; determining whether predetermined conditions about a time between acquisition of the preparation completion information and acquisition of the inspection start information are satisfied or not; and outputting warning information when the determining step determines that the predetermined conditions are satisfied.

In the disclosed patient burden easing support method, the determination step determines that the predetermined conditions are satisfied when a time elapsed since acquisition of the preparation completion information is beyond a first threshold, and determines that the predetermined conditions are not satisfied when the elapsed time does not reach the first threshold.

In the disclosed patient burden easing support method, the first threshold is set at a value which varies in accordance with at least one of a region to be inspected in the endoscopic inspection and a procedure of a doctor who performs the endoscopic inspection.

In the disclosed patient burden easing support method, the determination step determines that the predetermined conditions are satisfied when a time in which a subject who receives the endoscopic inspection is alone in a room where the endoscopic inspection is performed is beyond a second threshold, and determines that the predetermined conditions are not satisfied when the time does not reach the second threshold.

The disclosed patient burden easing support method further includes: acquiring data of a motion picture in a room where an endoscopic device for performing the endoscopic inspection is placed, the motion picture being imaged by a photographing device for photographing the inside of the room; and determining the number of persons included in the motion picture data, based on the motion picture data. The determination step determines that a time in which the number of persons is smaller than two, as the time in which the subject is alone in the room where the endoscopic inspection is performed.

In the disclosed patient burden easing support method, the inspection start information is data of a taken image obtained by a first still picture taken after connection of an endoscopic probe in an endoscopic device for performing the endoscopic inspection.

In the disclosed patient burden easing support method, the preparation completion information is a first frame of a motion picture taken after connection of an endoscopic probe in an endoscopic device for performing the endoscopic inspection.

In the disclosed patient burden easing support method, the warning information is information for sending a notification that a subject is kept waiting for a long time since completion of preparation for the endoscopic inspection.

A disclosed non-transitory computer readable medium causes a computer to execute each process of the patient burden easing support method.

What is claimed is:

1. A patient burden easing support apparatus for offering support to ease a burden on a patient who receives an endoscopic inspection, comprising:
a preparation completion information acquiring unit that acquires preparation completion information indicating that preparation for the endoscopic inspection has been completed;
an inspection start information acquiring unit that acquires inspection start information indicating that the endoscopic inspection has been started;
a determination unit that determines whether predetermined conditions about a time between acquisition of the preparation completion information and acquisition of the inspection start information are satisfied or not; and
a warning unit that outputs warning information when the determination unit determines that the predetermined conditions are satisfied.

2. The patient burden easing support apparatus according to claim 1, wherein:
the determination unit determines that the predetermined conditions are satisfied when a time elapsed since acquisition of the preparation completion information is beyond a first threshold, and determines that the predetermined conditions are not satisfied when the elapsed time does not reach the first threshold.

3. The patient burden easing support apparatus according to claim 2, wherein:
the first threshold is a value which varies in accordance with at least one of a region to be inspected in the endoscopic inspection and a procedure of a doctor who performs the endoscopic inspection.

4. The patient burden easing support apparatus according to claim 1, wherein:
the determination unit determines that the predetermined conditions are satisfied when a time in which a subject who receives the endoscopic inspection is alone in a room where the endoscopic inspection is performed is beyond a second threshold, and determines that the predetermined conditions are not satisfied when the time does not reach the second threshold.

5. The patient burden easing support apparatus according to claim 4, further comprising:
a motion picture data acquiring unit that acquires data of a motion picture in a room where an endoscopic device for performing the endoscopic inspection is placed, the motion picture being imaged by a photographing device for photographing the inside of the room; and
a number-of-persons determination unit that determines the number of persons included in the motion picture data, based on the motion picture data; wherein:
the determination unit determines that a time in which the number of persons is smaller than two, as the time in which the subject is alone in the room where the endoscopic inspection is performed.

6. The patient burden easing support apparatus according to claim 1, wherein:
the inspection start information is data of a taken image obtained by a first still picture taken after connection of an endoscopic probe in an endoscopic device for performing the endoscopic inspection.

7. The patient burden easing support apparatus according to claim 1, wherein:
the preparation completion information is a first frame of a motion picture taken after connection of an endoscopic probe in an endoscopic device for performing the endoscopic inspection.

8. The patient burden easing support apparatus according to claim 1, wherein:
the warning information is information for sending a notification that a subject is kept waiting for a long time since completion of preparation for the endoscopic inspection.

9. A patient burden easing support method performed by a computer to offer support to ease a burden on a patient who receives an endoscopic inspection, comprising:
acquiring preparation completion information indicating that preparation for the endoscopic inspection has been completed;
acquiring inspection start information indicating that the endoscopic inspection has been started;
determining whether predetermined conditions about a time between acquisition of the preparation completion information and acquisition of the inspection start information are satisfied or not; and
outputting warning information when the determining step determines that the predetermined conditions are satisfied.

10. The patient burden easing support method according to claim 9, wherein:
the determination step determines that the predetermined conditions are satisfied when a time elapsed since acquisition of the preparation completion information is beyond a first threshold, and determines that the predetermined conditions are not satisfied when the elapsed time does not reach the first threshold.

11. The patient burden easing support method according to claim 10, wherein:
the first threshold is set at a value which varies in accordance with at least one of a region to be inspected in the endoscopic inspection and a procedure of a doctor who performs the endoscopic inspection.

12. The patient burden easing support method according to claim 9, wherein:
the determination step determines that the predetermined conditions are satisfied when a time in which a subject who receives the endoscopic inspection is alone in a room where the endoscopic inspection is performed is beyond a second threshold, and determines that the predetermined conditions are not satisfied when the time does not reach the second threshold.

13. The patient burden easing support method according to claim 12, further comprising:
acquiring data of a motion picture in a room where an endoscopic device for performing the endoscopic inspection is placed, the motion picture being imaged by a photographing device for photographing the inside of the room; and
determining the number of persons included in the motion picture data, based on the motion picture data; wherein:
the determination step determines that a time in which the number of persons is smaller than two, as the time in which the subject is alone in the room where the endoscopic inspection is performed.

14. The patient burden easing support method according to claim 9, wherein:
the inspection start information is data of a taken image obtained by a first still picture taken after connection of an endoscopic probe in an endoscopic device for performing the endoscopic inspection.

15. The patient burden easing support method according to claim 9, wherein:
the preparation completion information is a first frame of a motion picture taken after connection of an endoscopic probe in an endoscopic device for performing the endoscopic inspection.

16. The patient burden easing support method according to claim 9, wherein:
the warning information is information for sending a notification that a subject is kept waiting for a long time since completion of preparation for the endoscopic inspection.

17. A non-transitory computer readable medium causing a computer to execute each process of the patient burden easing support method according to claim 9.
